(19) United States
(12) Patent Application Publication
(10) Pub. No.: US 2007/0065201 A1
(43) Pub. Date: Mar. 22, 2007

(54) Sheet conveying apparatus and image forming apparatus

(75) Inventors: Hiroshi Fujiwara, Osaka (JP); Yasuhide Ohkubo, Osaka (JP); Shigeo Nanno, Kyoto (JP); Ippei Kimura, Osaka (JP); Tomoyoshi Yamazaki, Osaka (JP); Masafumi Takahira, Osaka (JP)

Correspondence Address: HARNESS, DICKEY & PIERCE, P.L.C., P.O. BOX 8910, RESTON, VA, 20195, US

(73) Assignees: Ricoh Company, Limited; Ricoh Printing Systems, Ltd.

(21) Appl. No.: 11/520,005

(22) Filed: Sep. 13, 2006

(30) Foreign Application Priority Data
Sep. 20, 2005 (JP) 2005-272069

(51) Int. Cl. G03G 15/00

(52) U.S. Cl. 399/405

(57) ABSTRACT

A paper delivering roller has a shaft member made of resin to which two rubber rollers are attached. A housing that supports the paper delivering roller has side surface members, a lower guide member, an upper guide member, and a vertical guide surface that are integrally molded with resin. Because of the resin shaft member, the shaft member would be deflected and deformed by the pressing force of the follower rollers. Holding ribs of the upper guide member support the center portion in an axial direction, thereby suppressing such deflection and deformation. Although a deflection may occur also to the upper guide member, the paper delivering roller and the upper guide member are integrally deformed, and therefore a positional relation between the paper delivering roller and the upper guide member that guides the delivered sheet is kept constant.

### CROSS-REFERENCE TO RELATED APPLICATIONS

The present document incorporates by reference the entire contents of Japanese priority document, 2005-272069 filed in Japan on Sep. 20, 2005.

### BACKGROUND OF THE INVENTION

1. Field of the Invention

The present invention generally relates to conveying a paper sheet in an image forming apparatus and particularly relates to conveying a paper sheet by using a pair of rollers.

2. Description of the Related Art

In image forming apparatuses, such as printers, copiers, and facsimile machines, downsizing and light weight of the machine body have been demanded, and thus reduction in the number of components and resinification of the components are proceeding. Together with downsizing of the apparatuses, a conveying path tends to be shorter to improve printing speed and productivity. Since the distance from a fixing unit to a sheet delivery port becomes extremely short, the sheet is turn-guided in a heated state immediately after fixing. Moreover, due to downsizing of the fixing unit itself, for example, the amount of curling of the sheet tends to be large. This tends to cause failed insertion of the edge of the sheet into a conveyer roller, a sheet hung-up at the edge of a guide member, and buckling of a corner of the sheet, thereby degrading conveyance quality. Such problems associated with sheet conveyance occur to not only image forming apparatuses but also apparatuses that convey sheets and documents, such as image reading apparatuses (scanners) and automatic document feeders.

To prevent the degradation in conveyance quality, for example, a resinificated conveyer roller shaft is supported not only at both ends but also a center portion to suppress deflection of the roller shaft (refer to Japanese Patent Application Laid-Open No. 2002-284389). However, there is a problem that such support is not sufficient to stabilize sheet passing between the conveyer roller and the guide member. To address this problem, for example, a supplemental sheet-guide member including a film member made of Mylar (registered trademark) is added. Also, at a paper delivering unit, the rear edge of the sheet conveyed from the conveyer roller may remain in the guide member to cause a stack failure, and therefore a sheet holding member or the like is required. For these reasons, with the needs of a supplemental sheet-guide member and a sheet holding member, there are also problems of complicated configuration and increased cost due to an increase in the number of components.

Japanese Patent Application Laid-Open No. 2004-331391 discloses another related art.

### SUMMARY OF THE INVENTION

It is an object of the present invention to at least partially solve the problems in the conventional technology.

According to an aspect of the present invention, a sheet conveying apparatus includes a pair of conveyer rollers including a driving roller and a follower roller pressed onto the driving roller; and a sheet guide member that includes a both-end supporting member that supports a shaft member of the driving roller at both ends and a conveyer guide member that guides a sheet conveyed by the conveyer rollers, the both-end supporting member and the conveyer guide member being integrally configured, the conveyer guide member including a center supporting member that supports the shaft member of the driving roller at a center portion in an axial direction on a side opposite to the follower roller so as to face the follower roller.

According to another aspect of the present invention, a sheet conveying apparatus includes conveyer means including a driving roller and a follower roller pressed onto the driving roller; and sheet guide means that includes a both-end supporting member for supporting a shaft member of the driving roller at both ends and a conveyer guide member for guiding a sheet conveyed by the conveyer means, the both-end supporting member and the conveyer guide member being integrally configured, the conveyer guide member including a center supporting member for supporting the shaft member of the driving roller at a center portion in an axial direction on a side opposite to the follower roller so as to face the follower roller.

According to still another aspect of the present invention, an image forming apparatus includes the sheet conveying apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of an internal structure of a full-color printer according to an embodiment of the present invention;

FIG. 2 is a perspective view of a paper delivery unit shown in FIG. 1;

FIG. 3 is a perspective view of the paper delivery unit viewed from the inside of the printer shown in FIG. 1;

FIG. 4 is a perspective view of a housing of the paper delivery unit viewed from the outside of the printer shown in FIG. 1;

FIG. 5 is a perspective view of the housing viewed from the inside of the printer shown in FIG. 1; and

FIG. 6 is a side view of an internal structure of a scanner apparatus according to another embodiment of the present invention.

### DETAILED DESCRIPTION OF THE PREFERRED EMBODIMENTS

Exemplary embodiments of the present invention are explained below with reference to the accompanying drawings.

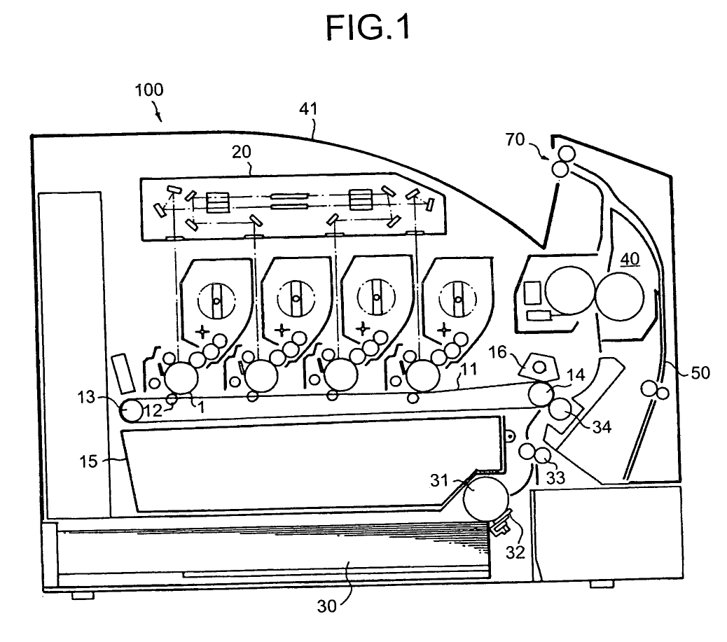

FIG. 1 is a side view of an internal structure of a full-color printer 100, which is an example of an image forming apparatus, according to an embodiment of the present invention. The full-color printer 100 includes an apparatus body that encloses an intermediate transfer belt 11 wound around a plurality of rollers. Along an upper running side of the intermediate transfer belt 11, four image forming units 10 (M, C, Y, Bk) are provided. The intermediate transfer belt 11 is rotatably driven in a counterclockwise direction in the drawing.

Each of the image forming units 10 includes a photosensitive drum 1 as an image carrier. Around this photosensitive drum 1, a charging unit, a developing unit, a cleaning unit, and others are disposed. Furthermore, a transfer roller 12 is provided as a primary transfer unit inside the intermediate transfer belt 11 so as to face the photosensitive drum 1. In this example, the four image forming units 10 are configured to have the same structure, but handle different four colors of developer: yellow, magenta, cyan, and black. In this example, the four image forming units 10 are disposed in the color order of, from left in the drawing, yellow, magenta, cyan, and then black. Each image forming unit 10 as a processor cartridge is removably provided to the apparatus body.

Above the four image forming units 10 is an optical writing unit 20. The optical writing unit 20 has a polygon mirror, a group of mirrors, and others to irradiate the surface of the photosensitive drum 1 of each image forming unit with optically-modulated laser light.

Below the intermediate transfer belt 11 is a waste toner bottle 15 for storing residual toner collected by a cleaning unit 16 for cleaning the intermediate transfer belt 11 and cleaning units (not provided with reference numerals in the drawing) for cleaning the photosensitive drums 1 of the respective image forming units 10. Further below the waste toner bottle 15 is a sheet feeding tray 30 for stacking sheets.

On the right side of the sheet feeding tray 30, a paper feeding roller 31 for feeding sheets stacked in the sheet feeding tray is provided. Against the paper feeding roller 31, a separating pad 32 is pressed for separating the sheets one by one. Above the paper feeding roller 31 and the separating pad 32 (on the downstream side of a sheet conveying direction) is a resist roller 33. Above the resist roller 33 is a transfer roller 34 as a secondary transferring unit so as to face a transfer facing roller 14, which is one of the rollers over which the intermediate transfer belt 11 spreads to form a secondary transfer unit.

Above the secondary transfer unit is a fixing unit 40. The fixing unit 40 according to this example has a fixing roller and a pressure roller, in which a sheet on which an unfixed toner image is heated and pressured by the secondary transfer unit for fixing. Above the fixing unit 40 is a paper delivering unit 70 that delivers a sheet after fixing onto a paper delivery tray 41 formed on the upper surface of the apparatus.

Also, in the drawing, a sheet reversing unit 50 is provided on the right side of the apparatus. For double-side printing, the sheet having an image formed on one surface is switched back after passing through the fixing unit 40 by reversing the direction of rotation of the paired rollers of the paper delivering unit 70 for feeding to the sheet reversing unit 50, which turns the sheet over and then feeds again to the resist roller 33.

An image forming operation of the full-color printer 100 is briefly explained next.

The photosensitive drum 1 of each image forming unit 10 is rotatably driven by a driving unit (not shown) in a clockwise direction in the drawing. The surface of the photosensitive drum 1 is uniformly electrically charged by a charging unit so that the surface has a predetermined polarity. The charged surface is irradiated with laser light from the optical writing unit 20, thereby forming an electrostatic latent image on the surface. At this time, image information exposed onto each photosensitive drum 1 is for single color obtained by breaking a desired full-color image into pieces of color information of yellow, magenta, cyan, and black. The electrostatic latent image formed in the manner is provided with toner of each color from the developing unit to be visualized as a toner image.

Also, the intermediate transfer belt 11 is driven so as to run in a counterclockwise direction in FIG. 1. With the operation of the primary transfer roller 12 in each image forming unit 10, toner images of respective colors are sequentially overlaid and transferred from each photosensitive drum 1 to the intermediate transfer belt 11. In this manner, a full-color tone image is carried on the surface of the intermediate transfer belt 11.

Here, one of the image forming units 10 can be used to form a single-color image, or an image of two or three colors can be formed. For monochrome print, the Bk unit on the far right side is used for image formation.

The residual toner attached on the surface of the photosensitive drum after transfer of the toner image is removed by the cleaning unit from the surface of the photosensitive drum. Then, the surface is under the operation of a static eliminator so as to initialize the surface potential for preparing for the next image formation.

On the other hand, a sheet is supplied from the sheet feeding tray 30, and then is sent by the paired resist rollers 33 to a secondary transfer position so as to match the timing of the toner image carried on the intermediate transfer belt 11. In the present example, the secondary transfer roller 34 is applied with a transfer voltage having a polarity reversed to a toner-charged polarity of each toner image on the surface of the intermediate transfer belt. With this, the toner images on the surface of the intermediate transfer belt are collectively transferred to the sheet. When the sheet with the toner images transferred thereto passes through the fixing unit 40, the toner images are fused and fixed to the sheet by heat and pressure. The fixed sheet is delivered by the paired rollers of the paper delivering unit 70 to the paper delivery tray 41 formed on the upper surface of the apparatus body.

For printing on both sides of the sheet, as explained above, the sheet with the toner image fixed to one side is switched back by reversing the direction of rotation of the paired rollers of the paper delivering unit 70 for feeding to the sheet reversing unit 50, which turns the sheet over and then feeds again to the resist roller 33. A toner image is transferred from the intermediate transfer belt 11 to the back surface of the sheet fed again, and then the back-surface image is fixed by the fixing unit 40. Then, the sheet carrying images on both surface sides is delivered to the paper delivery tray 41, thereby completing double-side printing.

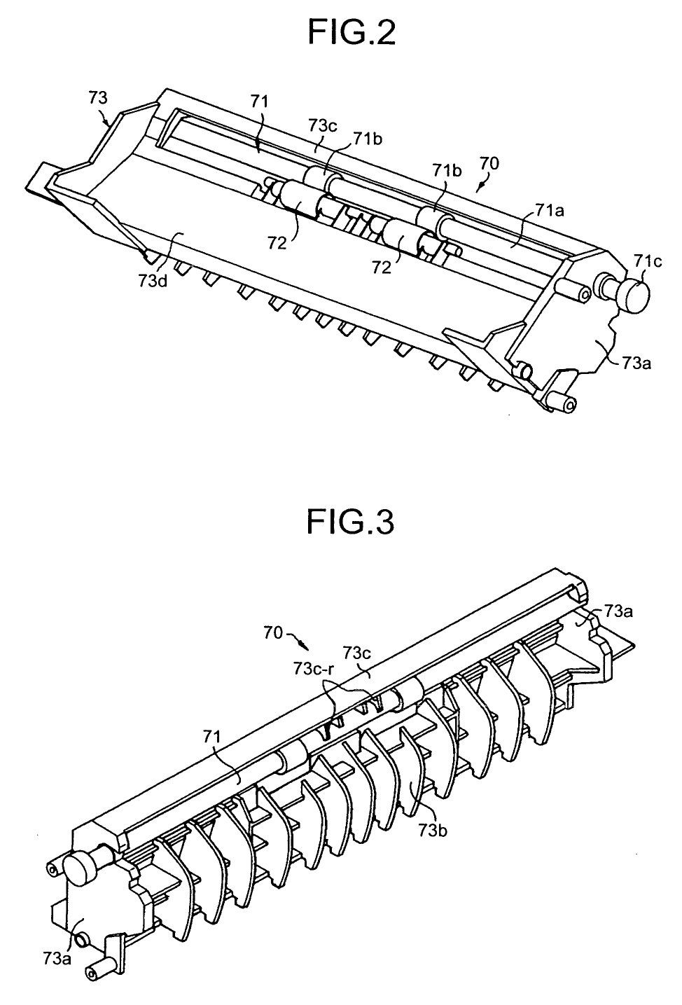

FIGS. 2 and 3 are perspective views of the paper delivering unit 70. FIG. 2 is a view from the outside, i.e., as seen from the side of the paper delivery tray 41 side, and FIG. 3 is a view from the inside, i.e, as seen from inside of the full-color printer 100.

The paper delivering unit 70 includes a paper delivering roller 71, follower rollers 72, a paper delivery housing 73, and a spring (not shown) that presses the follower rollers 72 onto the paper delivering roller 71. The paper delivery housing 73 holds the paper delivering roller 71 and the follower rollers 72, and includes guide members 73b that guides the sheet to the paper delivering roller 71.

The paper delivering roller 71 includes a shaft member 71a, made of resin, to which two rubber rollers 71b are attached. The outer diameter of the shaft member 71a is about 8 millimeters and is lightened for resin molding, whilst the outer diameter of the rubber rollers 71b is approximately 12 millimeters. The shaft member 71a has one end at which a gear 71c is integrally molded for receiving driving force from a driving unit not shown for rotatably driving the paper delivering roller 71. Resinification of the shaft, integration of the gear, and reduction in diameter of the rubber rollers contribute to a reduction in the number of components, light weight, and downsizing, leading to reduction in cost.

The two follower rollers 72 pressed onto the rubber rollers 71b of the paper delivering roller 71 are each integrally molded with resin with a shaft member having a small diameter protruding from roller members and both side surfaces of the roller members, and brim members (members to provide strength at the time of delivering the sheet) provided to an end of the roller members. With the shaft member of the both side surfaces of the roller members being supported and pressured, the shaft member is pressed onto the paper delivering roller 71.

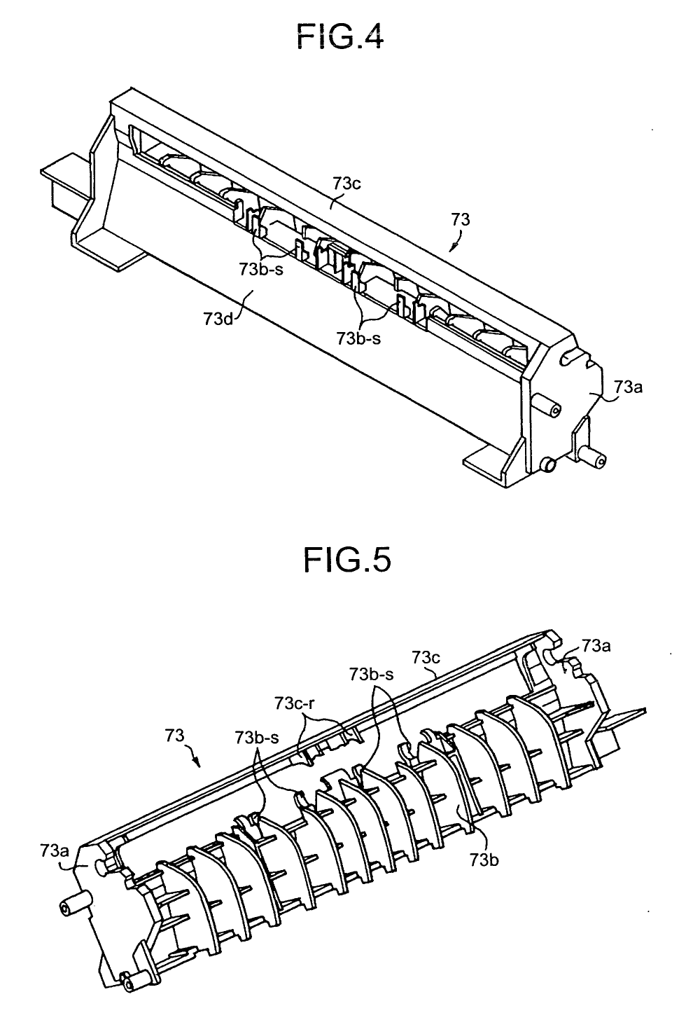

In the paper delivery housing 73, as depicted in FIGS. 4 and 5, side surface members 73a on both outer side in a longitudinal direction, a lower guide member 73b, an upper guide member 73c, and a vertical guide surface 73d are integrally molded. The side surface members 73a, which are both-end supporting members, are each provided with a holding member that holds the relevant end of the shaft member 71a of the paper delivering roller 71. Also, one of the side surface members 73a has formed thereto a positioning member serving as a reference for attaching the driving unit, a fixing boss, and others. With this, driving force can be reliably transmitted to the gear 71c integrally formed with the shaft member 71a of the paper delivering roller.

The lower guide member 73b, which is an introduction guide member, serves as a carrier guide that guides the sheet sent from the fixing unit 40 to the paper delivering roller 71, and includes a plurality of ribs. On that lower guide member 73b, four holding members 73b-s (one for each of both sides of each follower roller 72) are formed to support the shaft member of the follower rollers 72 and hold a pressure spring not shown. In the paper delivering unit 70 of this example, the side surface members 73a that holds the paper delivering roller 71 and the lower guide member 73b that pressures and supports the follower rollers 72 are integrally formed, thereby making it possible to accurately set a pressing position, pressing force, and a pressuring direction of the follower rollers 72 with respect to the paper delivering roller 71.

The upper guide member 73c is a carrier guide member that guides the sheet conveyed and delivered by the paper delivering roller 71 and the follower rollers 72. The upper guide member 73c has formed thereon holding ribs 73c-r that supports the center portion of the shaft member 71a of the paper delivering roller 71 (FIG. 5). The holding ribs 73c-r rotatably supports the paper delivering roller's shaft member 71a so as to oppose to the force acted on the paper delivering roller 71 by pressure of the follower rollers 72. Since the shaft member 71a is resin-molded, the paper delivering roller 71 has a stiffness lower than that of a metal shaft, and therefore would be deflected and deformed by the pressing force of the follower rollers 72. However, the holding ribs 73c-r of the upper guide member 73c support the center portion in an axial direction, thereby suppressing such deflection and deformation. Also, the upper guide member 73c is resin-molded, and therefore would be deflected by the pressing force of the follower rollers 72. However, also in this case, the paper delivering roller 71 and the upper guide member 73c are integrally deformed, and therefore a positional relation between the paper delivering roller 71 and the upper guide member 73c that guides the delivered sheet is kept constant. Thus, edge buckling or jam due to a sheet hung-up can be prevented from occurring.

The vertical guide surface 73d is a stack guide member for stacking delivered sheets on the paper delivery tray 41. This vertical guide surface 73d is formed on the opposite side of the lower guide member 73b, and guides the sheet delivered by the paper delivering roller 71 onto the paper delivery tray 41. With the vertical guide surface 73d being integrally and seamlessly formed, the number of components can be reduced, and a stack failure due to, for example, a hung-up at the rear end of a sheet when delivered sheets are stacked on the paper delivery tray can be prevented.

With the structure of the paper delivering unit 70, reduction in the number of components, downsizing, and light weight can be achieved. Also, sheet conveyance quality and delivered sheet stackability can be improved.

The present invention has been explained by using the example depicted in the drawings, but is not meant to be restricted to this example.

For example, although the paper delivering roller (71) has two rollers (71b) in the depicted example, the number or rollers can be arbitrary. Also, the number of follower rollers (72) can be any according to the number of rollers of the paper delivering roller. The material of each member can be arbitrary for use.

Furthermore, the paper delivering roller can be placed on a lower side, whilst the follower rollers can be placed on an upper side. Still further, the paper delivering roller and the follower roller forming paired paper delivering rollers can be placed in parallel. The supporting member, the holding member, and others for each roller can be placed according to the placing location and the placing direction of each roller.

Still further, the sheet conveying apparatus according to the present invention can be applied not only to a paper delivering unit but also to a sheet conveying unit of each unit of an image forming apparatus. The image forming scheme is not restricted to electrophotography, and the present invention can be applied to an apparatus in an arbitrary image forming scheme, such as an ink-jet scheme. As a matter of course, the image forming apparatus is not restricted to a printer, but may be a copier or facsimile machine, or may be a multifunction product having a plurality of functions. Still further, the present invention can be applied to sheet (document) conveying apparatus, such as an image reading apparatus (scanner) or an automatic document feeder.

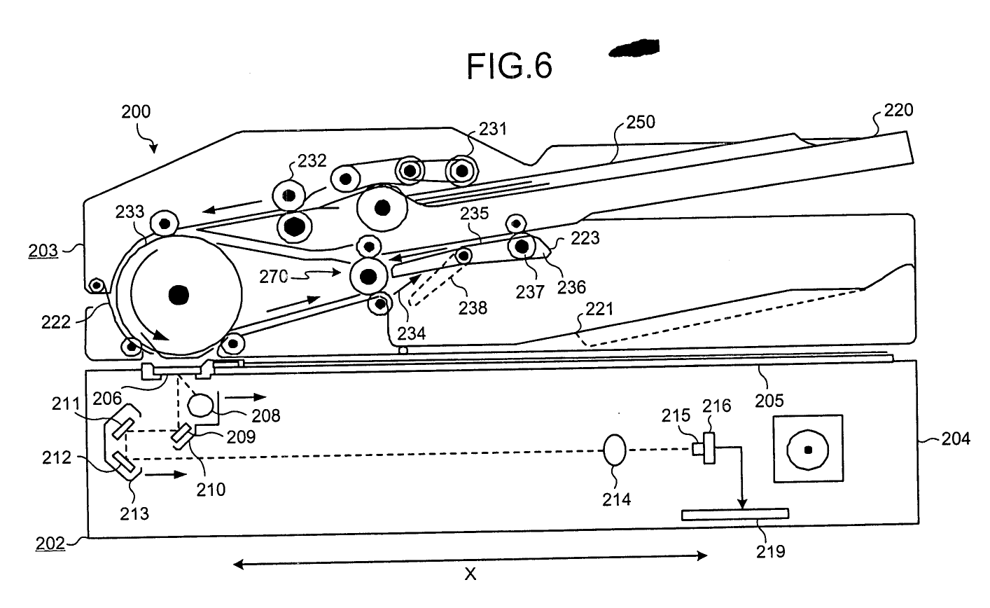

In an another embodiment, the sheet conveying apparatus is applied to a scanner apparatus including an automatic document feeder. FIG. 6 is a side view of an internal structure of a scanner apparatus 200 according to another embodiment of the present invention. As depicted in FIG. 6, the scanner apparatus 200 includes a scanner body 202 and a reversing automatic document feeder (RADF) 203, which is one type of an automatic document feeder (ADF) and serving as a automatic document feeding means, provided above the scanner body 202.

First, the scanner body 202 is explained. The scanner body 202 includes a box 204, which is provided on its upper surface with a document placement glass 205 on which a document is placed at the time of reading a document image in a book-document reading mode and an ADF document glass 206, which is a conveyed-document reading glass for use at the time of reading a document image in a sheet-document reading mode.

Here, the book-document reading mode is an operation mode of reading an image of a document placed on the document placement glass 205, whilst the sheet-document reading mode is an operation mode of reading an image of a document when the document is automatically fed by the RADF 203 and the automatically-fed document passes over the ADF document glass 206. Note that these operation modes can be set through a body operation panel (not shown) provided outside of the box 204.

Also, a first carriage 210 including a lighting lamp (xenon lamp) 208 as a light source and a mirror 209 is placed inside of the box 204 and at a position facing the document placement glass 205 from below so as to be movable in a sub-scanning direction X along the document placement glass 205. The lighting lamp 208 comes on upon being applied with a driving voltage from a lamp stabilizer (not shown) to irradiate a reading surface at a predetermined angle. On a reflected light path of the first carriage 210, a second carriage 213 including two mirrors 211 and 212 is movably placed in the sub-scanning direction X along the document placement glass 205. On a reflected light path of the second carriage 213 via a lens 214, a sensor board unit (SBU) 216 is positioned, which is a charged-coupled-device (CCD) driving unit including a color CCD 215, which is a color image sensor. The SBU 216 outputs a voltage corresponding to an incident light amount to a scanner control unit (SCU) 219, which will be explained further below, as image data.

Also, in a lower portion of the inside of the box 204, a unit board is incorporated wherein the SCU 219 and other components forming an electric system for controlling the operation of the color image scanner 200 including the scanner body 202 and the RADF 203.

Next, the RADF 203 for use under the setting of the sheet-document reading mode is explained. Under the setting of the sheet-document reading mode, with the first carriage 210 and the second carriage 213 being stopped at a home position below the ADF document glass 206, and a document automatically fed from the RADF 203 is subjected to scan reading.

The RADF 203 includes a document table 220 for placing a document 250 at the time of reading the document in the sheet-document reading mode, a paper delivering unit 221 for delivering the document 250 after reading is completed, a document conveying path 222 communicating from the document table 220 to the paper delivering unit 221, and a reversing unit 223 that reverses the document 250 in a both-side reading mode. Here, the both-side reading mode is a sheet-document reading mode in which, after the document 250 is automatically fed by the RADF 203 for reading and scanning an image on the front surface, the document 250 is reversed for reading and scanning the image on the back surface.

On the document table 220 side of the document conveying path 222, a pick-up roller 231 and a conveyer roller 232 are provided for separating and feeding sheets stacked on the document table 220 one by one. These pick-up roller 231 and conveyer roller 232 are driven by a paper feeding motor (not shown). That is, with the pick-up roller 231 and the conveyer roller 232 being rotatably driven by the paper feeding motor, the document 250 placed on the document table 220 is fed to the document conveying path 222 one by one.

In addition, the document conveying path 222 is provided with a conveyer drum 233 for conveying the document 250 to the paper delivering unit 221. Below this conveyer drum 233 is the ADF document glass 206. This conveyer drum 233 is driven by a stepping motor (not shown). Therefore, with the conveyer drum 233 being rotatably driven by the stepping motor, the document 250 fed from the document table 220 to the document conveying path 222 is guided over the ADF document glass 206.

With this, the document 250 placed on the document table 220 is fed by the pick-up roller 231 one by one, and is conveyed by the conveyer roller 232 and the conveyer drum 233 to the ADF document glass 206, that is, the document reading position.

Also, the reversing unit 223 is provided with a reversing table 236 for forming a reversing path 235 having one end communicating with a branching point 234 branched from the middle of the document conveying path 222. This reversing table 236 is provided with a reversing roller 237 rotatably driven by a paper-feeding/reversing motor (not shown) in both normal and reversed manner. Also, the reversing path 235 has attached thereto a branching claw 238 that can be freely rotated about a spindle. With rotation of the spindle, the reversing path 235 is opened or closed with respect to the document conveying path 222. Thus, with this branching claw 238, the document 250 conveyed from the conveyer drum 233 to a paper delivering unit 270 is distributed to either one of the reversing unit 223 and the paper delivering unit 221. That is, if the both-side reading mode, which is a sheet-document reading mode, is set, the branching claw 238 opens the reversing path 235 with respect to the document conveying path 222 through rotation of the spindle, thereby guiding the document 250 conveyed by the conveyer drum 233 to the reversing path 235. Then, the document 250 in a reversed state is again conveyed by the reversing roller 237 to the document conveying path 222.

In the scanner apparatus 200, the sheet conveying apparatus can be applied to a curved portion where the document 250 passes after being fed until it is guided to the reading position on the ADF document glass 206, and also to a guide (paper delivering unit 270) for the document 250 after passing through the reading position to a paper delivery port.

According to the sheet conveying apparatus according to the present invention, a both-end supporting member and a conveyer guide member are integrally configured, and a center supporting member is provided to the conveyer guide member. Therefore, the number of components forming the sheet conveying apparatus can be reduced to achieve downsizing and light weight. Also, deflection and deformation of a driving roller shaft unit can be suppressed by the center supporting unit to improve sheet conveyance quality.

With the structure according to one aspect of the present invention, a driving roller and a conveyer guide member can be integrally deformed. Therefore, a positional relation between the driving roller and the conveyer guide member can be kept constant, thereby improving conveyance quality.

With the structure according to another aspect of the present invention, the driving roller is configured of a resin shaft member and a rubber roller. Therefore, the number of components can be reduced. Also, with the resin shaft member, the driving roller (shaft unit) can be easily deformed.

With the structure according to still another aspect of the present invention, the resin shaft member has integrally molded therein a drive transmitting member that receives driving force. Therefore, the number of components can be reduced.

With the structure according to still another aspect of the present invention, the sheet guide member has an introduction guide member that guides a sheet to paired conveyer rollers, the introduction guide member integrally formed with the both-end supporting unit. Therefore, the number of components forming the sheet conveying apparatus can be reduced to achieve downsizing and light weight. Also, a sheet can be reliably guided to the paired conveyer rollers, thereby improving conveyance quality.

With the structure according to still another aspect of the present invention, the introduction guide member is provided with a holding member that holds a pressuring member that supports the follower roller and pressures the follower roller onto the driving roller. Therefore, the number of components forming the sheet conveying apparatus can be reduced to achieve downsizing and light weight. Also, the pressure position, pressuring direction, and applied pressure of the follower roller with respect to the driving roller can be accurately set, thereby improving conveyance quality.

With the structure according to still another aspect of the present invention, the follower roller has brim members for providing strength to the sheet conveyed by the paired conveyer rollers. Therefore, sheet buckling or the like can be prevented to improve conveyance quality.

With the structure according to still another aspect of the present invention, a fixing unit and a positioning unit for fixing a driving unit are provided to one side of the both-end supporting member. Therefore, the number of components can be reduced. Also, the driving force can be reliably transmitted to the driving roller.

With the structure according to still another aspect of the present invention, the sheet conveying apparatus is a paper delivery unit that delivers a sheet to a sheet loading unit, and has a stack guide member that guides loading of the sheets delivered to the sheet loading unit, the stack guide member integrally formed with the both-end supporting member. Therefore, the number of components can be reduced, and also sheet stackability can be improved.

According to the image forming apparatus, the image reading apparatus, and the automatic document feeder according to still another aspect of the present invention, downsizing and light weight of a sheet conveying unit can be achieved. Also, sheet conveyance quality can be improved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet conveying apparatus comprising:
a pair of conveyer rollers including a driving roller and a follower roller pressed onto the driving roller; and
a sheet guide member that includes a both-end supporting member that supports a shaft member of the driving roller at both ends and a conveyer guide member that guides a sheet conveyed by the conveyer rollers, the both-end supporting member and the conveyer guide member being integrally configured, the conveyer guide member including a center supporting member that supports the shaft member of the driving roller at a center portion in an axial direction on a side opposite to the follower roller so as to face the follower roller.

2. The sheet conveying apparatus according to claim 1, wherein the driving roller and the conveyer guide member are configured to deform integrally.

3. The sheet conveying apparatus according to claim 2, wherein the driving roller includes a shaft member made of resin and a roller made of rubber and attached to the shaft member.

4. The sheet conveying apparatus according to claim 3, wherein the shaft member includes a drive transmitting member that is fixed to the shaft member and that receives a driving force.

5. The sheet conveying apparatus according to claim 1, wherein the sheet guide member includes an introduction guide member that guides a sheet to the conveyer rollers, the introduction guide member being integrally formed with the both-end supporting member.

6. The sheet conveying apparatus according to claim 5, wherein the introduction guide member includes a holding member that holds a pressuring member that supports the follower roller and pressures the follower roller onto the driving roller.

7. The sheet conveying apparatus according to claim 1, wherein the follower roller includes brim members for providing strength to the sheet conveyed by the conveyer rollers.

8. The sheet conveying apparatus according to claim 1, further comprising a fixing unit and a positioning unit for fixing a driving unit arranged at one side of the both-end supporting member.

9. The sheet conveying apparatus according to claim 1, wherein
the sheet conveying apparatus is a paper delivery unit that delivers a sheet to a sheet loading unit, and has a stack guide member that guides loading of the sheets delivered to the sheet loading unit, the stack guide member integrally formed with the both-end supporting member.

10. A sheet conveying apparatus comprising:
conveyer means including a driving roller and a follower roller pressed onto the driving roller; and
sheet guide means that includes a both-end supporting member for supporting a shaft member of the driving roller at both ends and a conveyer guide member for guiding a sheet conveyed by the conveyer means, the both-end supporting member and the conveyer guide member being integrally configured, the conveyer guide member including a center supporting member for supporting the shaft member of the driving roller at a center portion in an axial direction on a side opposite to the follower roller so as to face the follower roller.

11. An image forming apparatus comprising a sheet conveying apparatus, the sheet conveying apparatus including
a pair of conveyer rollers including a driving roller and a follower roller pressed onto the driving roller; and
a sheet guide member that includes a both-end supporting member that supports a shaft member of the driving roller at both ends and a conveyer guide member that guides a sheet conveyed by the conveyer rollers, the both-end supporting member and the conveyer guide member being integrally configured, the conveyer guide member including a center supporting member that supports the shaft member of the driving roller at a center portion in an axial direction on a side opposite to the follower roller so as to face the follower roller.
